(19) United States
(12) Patent Application Publication
(10) Pub. No.: US 2010/0304213 A1
(43) Pub. Date: Dec. 2, 2010

(54) BATTERY WITH FILLHOLE AND REDUNDANT SEAL

(75) Inventors: Stephanie Breimon, Delano, MN (US); Stephen Daniel Arco, Woodbury, MN (US); Bernard Frank Heller, JR., Shoreview, MN (US); Pankaj Mohan, Maple Grove, MN (US); Walter C. Sunderland, Eagan, MN (US); Paul M. Boucher, Lake Elmo, MN (US); Jeffrey J. Louwagie, Minnetonka, MN (US)

Correspondence Address: MEDTRONIC, INC., 710 MEDTRONIC PARKWAY NE, MINNEAPOLIS, MN, 55432-9924, US

(73) Assignee: MEDTRONIC, INC., Minneapolis, MN (US)

(21) Appl. No.: 12/621,132

(22) Filed: Nov. 18, 2009

Related U.S. Application Data
(60) Provisional application No. 61/182,351, filed on May 29, 2009.

(51) Int. Cl. H01M 2/08

(52) U.S. Cl. 429/185; 29/623.2

(57) ABSTRACT

A method of manufacturing an energy storage device for a medical device includes enclosing a cell assembly in a case. The case includes a filling aperture. The filling aperture includes an inner surface that is integral to the case so as to be monolithic. The case is free of a separate fill port tube. Moreover, the method includes introducing an electrolyte into the case through the filling aperture and hermetically sealing the filling aperture to form a first seal of the filling aperture that is free of a filler material. The method additionally includes hermetically sealing the sealing member to the case to form a second seal of the filling aperture.

### CROSS-REFERENCE TO RELATED APPLICATIONS

This application claims the benefit of U.S. Provisional Application No. 61/182,351, filed on May 29, 2009. The entire disclosure of the above application is incorporated herein by reference.

### FIELD

The present disclosure relates to a battery for a medical device, and in particular, to a battery for a medical device with a fillhole with a redundant seal.

### INTRODUCTION

Several medical devices include an energy storage device, such as an internal battery, that supplies power for maintaining proper function. For instance, implantable cardiac pacemaker and defibrillator devices often include a battery and/or a capacitor, which provides power so that the device can provide predetermined electrical signals to cardiac tissue. These devices are typically designed to be robust and to have a relatively long operating life.

Oftentimes, these devices include a housing assembly that can house an anode and a cathode. The housing assembly typically includes a hollow case with a separate fill port tube that extends through the case. During manufacture, the fill port tube can be inserted through an aperture in the case, then the outer surface of the fill port tube can be welded to the case, and the weld can be checked for leakage. Once the anode and cathode are housed within the case, an electrolyte can be introduced into the housing through the fill port tube. Subsequently, the fill port tube can be sealed using a filler material, such as a ball that is pressed and sealed inside the fill port tube, and the like.

Thus, the case of the energy storage device can include several separate components, including the fill port tube, filler material, etc. Also, coupling the fill port tube to the case and sealing the fill port tube can require several separate steps. Accordingly, manufacturing of the energy storage device can be relatively expensive and complex.

### SUMMARY

This section provides a general summary of the disclosure, and is not a comprehensive disclosure of its full scope or all of its features.

A method of manufacturing an energy storage device for a medical device is disclosed. The method includes enclosing a cell assembly in a case. The case includes a filling aperture. The filling aperture includes an inner surface that is integral to the case so as to be monolithic. The case is free of a separate fill port tube. Moreover, the method includes introducing an electrolyte into the case through the filling aperture and hermetically sealing the filling aperture to form a first seal of the filling aperture that is free of a filler material. The method additionally includes hermetically sealing the sealing member to the case to form a second seal of the filling aperture.

Furthermore, an energy storage device for a medical device is disclosed that includes a cell assembly, and a case that houses the cell assembly. The device also includes a filling aperture in the case. The filling aperture includes an inner surface that is integral to the case so as to be monolithic, and the filling aperture is free of a separate fill port tube. Furthermore, the device includes a first seal that substantially hermetically seals the filling aperture. The first seal is free of a filler material. Also, the device includes a sealing member and a second seal that substantially hermetically seals the sealing member to the case. The second seal is redundant to the first seal and redundantly seals the filling aperture.

Still further, a method of manufacturing an energy storage device for a cardiac medical device is disclosed. The method includes enclosing a cell assembly in a case and forming a recess and a filling aperture in the case. The filling aperture is disposed within the recess, and the filling aperture includes an inner surface that is integral to the case so as to be monolithic. The case is free of a separate fill port tube. Moreover, the method includes introducing an electrolyte into the case through the filling aperture and fusion welding the filling aperture closed free of a filler material to form a first hermetic seal of the filling aperture. Additionally, the method includes positioning a rounded, disc-shaped sealing member in the recess such that the sealing member is completely disposed between an inner surface of the recess and an imaginary surface defined by an outer rim of the recess. Also, the method includes welding the sealing member to the case to form a second hermetic seal of the filling aperture.

Moreover, a method of manufacturing an energy storage device for a medical device is disclosed. The method includes moving a tab portion of a case away from a surrounding portion of the case to define a filling aperture through the case. The tab portion remains partially attached to the surrounding portion. The method also includes introducing an electrolyte into the case through the filling aperture, moving the tab portion toward the surrounding portion, and hermetically sealing the filling aperture.

Furthermore, an energy storage device for a medical device is disclosed. The device includes a cell assembly and a case that houses the cell assembly. The case includes a tab having a first portion that is monolithically coupled to a surrounding portion of the case and a second portion that is detached from the surrounding portion. A filling aperture through the case is defined between the second portion of the tab and the surrounding portion of the case. The device further includes a first seal that hermetically seals the filling aperture.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected exemplary embodiments and not all possible implementations, and are not intended to limit the scope of the present disclosure.

FIG. 1 is a schematic view of a medical device having a battery according to various exemplary embodiments of the present disclosure;

FIG. 2 is an exploded view of the battery of the medical device of FIG. 1;

FIGS. 3A-3D are sectional views of a header portion of the battery of FIG. 1, illustrating an exemplary embodiment of a method of manufacturing the battery;

FIG. 4A-4C are top views of the header portion of the battery of FIG. 1, illustrating another exemplary embodiment of a method of manufacturing the battery; and

FIG. 5A-5D are top views of the header portion of the battery of FIG. 1, illustrating another exemplary embodiment of a method of manufacturing the battery.

Corresponding reference numerals indicate corresponding parts throughout the several views of the drawings.

### DETAILED DESCRIPTION

Exemplary embodiments will now be described more fully with reference to the accompanying drawings.

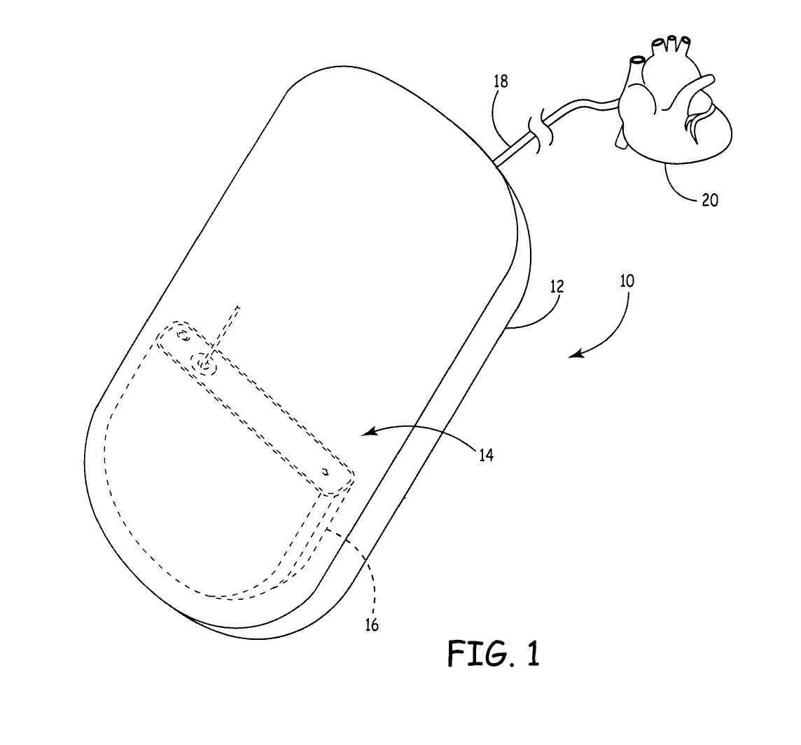

Referring initially to FIG. 1, a medical device 10 is schematically illustrated. The medical device 10 can include a housing assembly 12 and various internal components, generally indicated at 14. The internal components 14 can be housed within the housing assembly 12. The internal components 14 can include a computerized controller, logic, and circuitry (not specifically shown) for operation of the medical device 10. The internal components 14 can also include an energy storage device 16, such as a battery, which is shown in phantom in FIG. 1. As will be discussed, the energy storage device 16 stores and supplies power to other internal components 14 of the medical device 10.

It will be appreciated that the medical device 10 can be of any suitable type. For instance, the medical device 10 can be an implantable cardiac pacemaker (IPG) or a defibrillator (ICD); however, the medical device 10 can be of another type for providing electrical stimulation therapy (e.g., brain stimulation for treatment of Parkinson's disease or tremor, muscle pain, or other nerve stimulation).

The medical device 10 can include a flexible lead 18 that extends from the housing assembly 12 and that electrically connects the internal components 14 of the medical device 10 to cardiac tissue 20 or other biological tissue of a patient. Thus, the internal components 14 of the medical device 10 can generate electrical signals that are transmitted to the cardiac tissue 20 via the lead 18 to maintain proper function of the cardiac tissue 20.

It will also be appreciated that the energy storage device 16 could be of any other suitable type other than a battery without departing from the scope of the present disclosure. For instance, the energy storage device 16 could instead be a capacitor that stores energy and that discharges energy at a predetermined time. Moreover, it will be appreciated that the medical device 10 could include a plurality of energy storage devices 16, such as a battery and a capacitor.

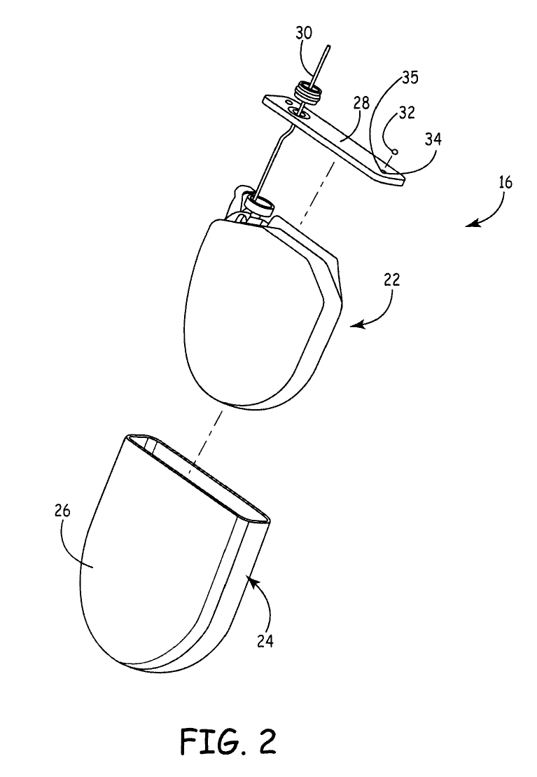

Referring now to FIG. 2, an exemplary embodiment of the energy storage device 16 of the medical device 10 is shown in greater detail. The energy storage device 16 can include a cell assembly 22. The cell assembly 22 can include an electrochemical cell with an anode, cathode, separator, and an electrolyte (not specifically shown). A chemical reaction between the cathode and the anode can generate electricity for the medical device 10.

The energy storage device 16 can also include a case 24 that encloses the cell assembly 22. The case 24 can include a main portion 26 and a header portion 28. The main portion 26 can be relatively thin-walled and hollow and can receive the cell assembly 22. The header portion 28 can be a thin, elongate plate that is fixed to the main portion 26 to encapsulate the cell assembly 22 within the case 24. The main portion 26 and the header portion 28 can be fixed in any suitable fashion. For instance, the header portion 28 can be welded to the main portion 26 about an entire periphery of the header portion 28.

The energy storage device 16 can also include a connector 30 that extends through the header portion 28. The connector 30 can be an electrically conductive wire or pin that is electrically connected to the cell assembly 22 and that is electrically insulated from the header portion 28. It will be appreciated that the connector 30 can be electrically coupled to the internal components 14 of the medical device 10 for supplying electricity from the cell assembly 22 thereto.

As shown in FIG. 2, the energy storage device 16 can include a filling aperture 34 included in the header portion 28. The filling aperture 34 can be a through-hole that extends through the header portion 28. As will be discussed in greater detail, the filling aperture 34 can be used for introducing an electrolyte into the case 24. Once a sufficient amount of electrolyte has been introduced into the case 24, the filling aperture 34 can be hermetically sealed by a first seal 35. For instance, the filling aperture 34 can be welded (e.g., by laser welding) in order to create the first seal 35 and to create a substantially hermetic seal of the filling aperture 34.

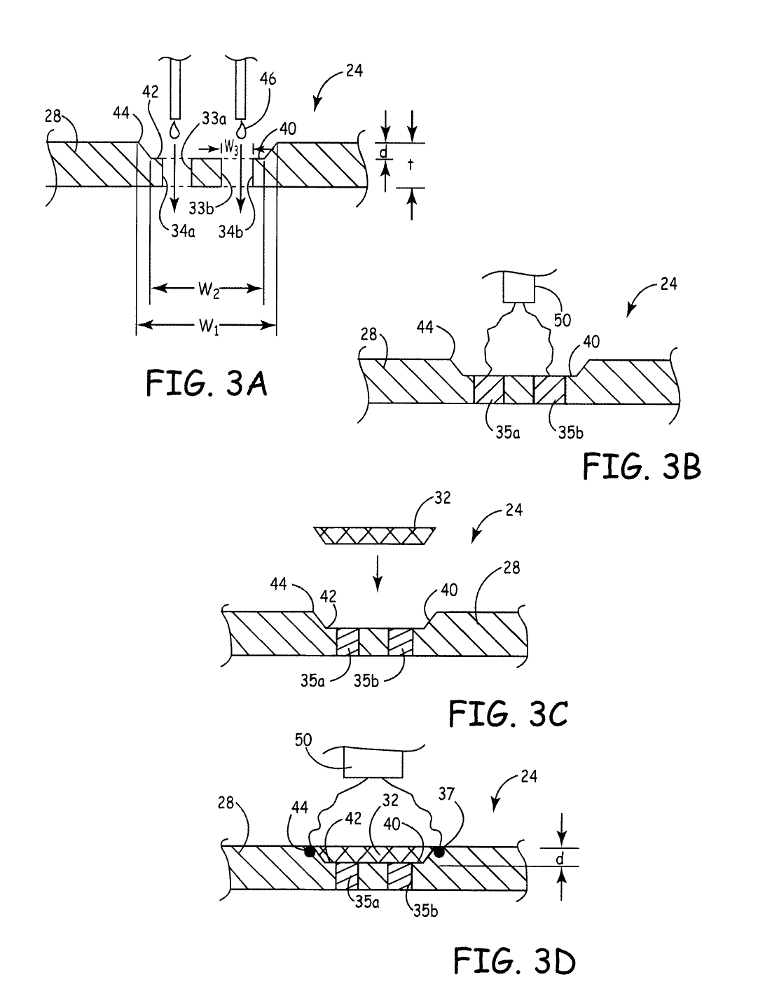

Furthermore, as shown in FIG. 2, the energy storage device 16 can include a sealing member 32. The sealing member 32 can be a rounded, disc-shaped member made out of any suitable material, such as titanium or a titanium-based alloy. As will be discussed in greater detail below, the sealing member 32 can be disposed over the filling aperture 34 and the first seal 35, and the sealing member 32 can be hermetically sealed to the case 24 to create a second seal 37 (see FIG. 3D). For instance, an entire periphery of the sealing member 32 can be fusion welded (e.g., laser welded, arc welded, plasma welded, etc.) to the case 24 to create the second seal 37. Thus, the second seal 37 is redundant to the first seal 35 (i.e., redundantly seals the filling aperture 36). Accordingly, if the first seal 35 were to fail, the filling aperture 34 can remain sealed due to the second seal 37. Thus, the electrolyte is unlikely to leak from the case 24 and/or foreign materials are unlikely to enter the case 24 and contaminate the cell assembly 22. Furthermore, as will be discussed, the filling aperture 34 can be sealed with relatively few parts, and the filling aperture 34 can be sealed relatively simply and inexpensively.

Manufacture of the energy storage device 16, specifically creation of and hermetic sealing of the filling aperture 34, will now be discussed according to an exemplary embodiment shown in FIGS. 3A-3D. The header portion 28 is shown in FIG. 3A. The header portion 28 can be of any suitable thickness, t. In some embodiments, the thickness, t, of the header portion 28 is between approximately 0.004 and 0.032 inches thick (e.g., approximately 0.008 inches). Also, the header portion 28 can be made out of any suitable material, such as titanium or a titanium-based alloy.

Moreover, the header portion 28 can include a recess 40 with an inner surface 42 and an outer rim 44. The recess 40 can be formed in any suitable fashion, such as a coining or stamping operation, and can have any suitable shape. The recess 40 can have any suitable depth, d, such as approximately a depth, d, of 0.01 inches; however, the depth, d, of the recess can be dependent on the thickness, t, of the header portion 28. Furthermore, the recess 40 can be tapered to have an outer width, w₁, (e.g., outer diameter) that is greater than an inner width, w₂, (e.g., inner diameter). In some exemplary embodiments, the recess 40 can be tapered at an angle that is oriented approximately 30 degrees to 45 degrees with respect to the axis of the recess. However, it will be appreciated that the recess 40 can have any suitable taper. Also, the recess 40 can have a substantially constant width, w₁, without departing from the scope of the present disclosure.

Furthermore, as shown in FIG. 3A, the header portion 28 can have a plurality of filling apertures 34a, 34b that are each spaced apart from each other within the recess 40. Each of the filling apertures 34a, 34b can be through holes with a respective straight axis that extends through the header portion 28. The filling apertures 34a, 34b can each include an inner surface 33a, 33b (FIG. 3A). Each respective inner surface 33a, 33b can be integral to the header portion 28 of the case 24 so as to be monolithic.

It will be appreciated that the case 24 can include any number of filling apertures 34a, 34b. In some exemplary embodiments, the header portion 28 includes between one and six filling apertures 34a, 34b. The filling apertures 34a, 34b can be formed in any suitable fashion, such as drilling (laser drilling or otherwise), punching, milling, and the like. Also, the filling apertures 34a, 34b can have any suitable shape and size. For instance, the filling apertures 34a, 34b can have a width, w₃, (e.g., a diameter) measuring approximately 0.004 inches to approximately 0.03 inches. Moreover, the filling apertures 34a, 34b can be included anywhere on the case 24 other than the header portion 28. Likewise, the recess 40 can be included anywhere on the case 24 other than the header portion 28. For instance, the filling apertures 34a, 34b and the recess 40 can be included on the main portion 26 (FIG. 2) of the case 24 without departing from the scope of the present disclosure.

Additionally, it will be appreciated that the size (e.g., diameter) of the filling apertures 34a, 34b can be adapted according to certain manufacturing parameters. For instance, if the apertures 34a, 34b are formed using a punching tool (not shown), the diameter of the filling apertures 34a, 34b can be such that the punching tool is unlikely to fracture or otherwise fail. More specifically, if the thickness of the header within the recess 40 (thickness=t−d) is relatively large, the filling apertures 34a, 34b can have a relatively large width, w₃, to ensure that the punching tool punches through the thickness, t, without failure. In contrast, if the thickness of the header within the recess 40 is relatively small, the width, w₃, of the filling apertures 34a, 34b can be smaller. Thus, it will be appreciated that the recess 40 can allow the apertures 34a, 34b to be smaller in width, w₃, if desirable.

An electrolyte 46 can be introduced into the case 24 through one or more of the filling apertures 34a, 34b as shown in FIG. 3A. It will be appreciated that the electrolyte 46 can be of any suitable type and can be supplied in any suitable amount. Accordingly, a separate fill port tube of the type known in the prior art (i.e., a hollow tube that is separate from the case 24) is unnecessary for supplying the electrolyte 46 into the case 24. Instead, the case 24 is free of a separate fill port tube, and the electrolyte 46 can be supplied directly through the apertures 34a, 34b. As such, manufacture of the device 10 can be accomplished with less parts and less expensively as will be discussed in greater detail below.

Furthermore, it will be appreciated that the number and size of filling apertures 34a, 34b can be adapted according to a desired flow rate of the electrolyte 46 into the case 24. For instance, a larger number and/or wider filling apertures 34a, 34b can allow the electrolyte 46 to flow more quickly into the case 24. In contrast, a smaller number and/or smaller filling apertures 34a, 34b can be included if the flow rate of the electrolyte 46 is lower. Thus, the number and/or size of the apertures 34a, 34b can be adapted, for instance, to advantageously provide a desired manufacturing through-put.

Once a desired amount of electrolyte has been introduced into the case 24, a plurality of first seals 35a, 35b can be formed to hermetically seal each of the filling apertures 34a, 34b. The first seals 35a, 35b can be formed according to the teachings of U.S. Pat. No. 7,442,466, issued Oct. 28, 2008, to Casby et al. As mentioned above, a fusion welding tool 50, such as a laser welding, arc welding, or plasma welding tool can create the first seals 35a, 35b and hermetically seal the filling apertures 34a, 34b. It will be appreciated that a single first seal 35a, 35b can seal the plural filling apertures 34a, 34b.

It will be appreciated that the first seals 35a, 35b can seal the apertures 34a, 34b, respectively, without the use of separate filler material, such as a ball, cap, button, or other member inserted in the apertures 34a, 34b. For instance, welding energy from the tool 50 can create a weld pool large enough to cause the width, w₃, of the apertures 34a, 34b to reduce to zero, such that the apertures 34a, 34b eventually seal closed. In some embodiments, the tool 50 can be offset from the respective axes of the apertures 34a, 34b such that the weld beam from the tool 50 creates a larger weld pool, and the first seals 35a, 35b are more robust. Thus, because filler material separate from the case 24 is unnecessary, the apertures 34a, 34b can be sealed in a relatively simple and inexpensive manner.

Moreover, welding can be performed with the liquid electrolyte 46 present along the inner surfaces 33a, 33b of the apertures 34a, 34b. (As used herein, the term “in the presence of the electrolyte” in reference to welding processes can generally refer to welding or sealing the apertures 34a, 34b closed without the use of a separate filler member or material separating the electrolyte 46 from the weld joint.) More specifically, the tool 50 can apply (i.e., pulse) a weld beam to the header portion 28 for a short interval of time in the presence of electrolyte 46 to quickly wet the inner surfaces 33a, 33b of the apertures 34a, 34b. Limited volatilization of the electrolyte 46 can occur as a result, limiting excessive gas formation that might otherwise yield a porous, ineffective weld joint.

Once the first seals 35a, 35b are formed, the sealing member 32 can be positioned and disposed within the recess 40 over the first seals 35a, 35b (FIG. 3C). As shown, the sealing member 32 can be shaped according to the recess 40 so as to substantially fill the recess 40. More specifically, the sealing member 32 can be tapered according to the tapered shape of the recess 40. Thus, the recess 40 can help position the sealing member 32 over the first seals 35a, 35b.

Then, as shown in FIG. 3D, the second seal 37 can be formed to hermetically seal the sealing member 32 to the case 24. The second seal 37 can be formed between the periphery of the sealing member 32 and the outer rim 44 of the recess 40 in the shape of a closed loop. As mentioned above, a welding tool 50, such as a laser welding tool, arc welding tool, or plasma welding tool can create the second seal 37.

As shown in FIG. 3D, the thickness of the sealing member 32 can be approximately equal to or less than the depth, d, of the recess 40. Accordingly, the sealing member 32 can be disposed completely within the recess 40 between the inner surface 42 of the recess 40 and an imaginary surface defined by the outer rim 44 of the recess 40. Thus, the sealing member 32 is unlikely to interfere with surrounding components of the energy storage device 16 and/or the medical device 10.

Thus, the manufacture of the energy storage device 16 can be cost efficient and time efficient as well. This is because the energy storage device 16 can include fewer separate parts and steps necessary for filling the energy storage device 16 with electrolyte and for sealing the filling apertures 34a, 34b. Also, because there are fewer separate parts, the seal of the energy storage device 16 can be more robust. Furthermore, because of the recess 40, the sealing member 32 can fit entirely within the recess 40 and is less likely to interfere with surrounding structure. Also, the recess 40 helps to properly orient and position the sealing member 32 before creating the second seal 37. Still further, the redundant sealing provided by both the first and second seals 35a, 35b, 37 ensures that the filling apertures 34a, 34b are unlikely to leak or allow contamination of the energy storage device 16.

It will be appreciated that the energy storage device 16 can include only the first seals 35a, 35b for sealing the filling apertures 34a, 34b. It will also be appreciated that the energy storage device 16 can include only the second seal 37 for sealing the filling apertures 34a, 34b. Furthermore, it will be appreciated that the header portion 28 of the case 24 can be relatively flat, without the recess 40 without departing from the scope of the present disclosure.

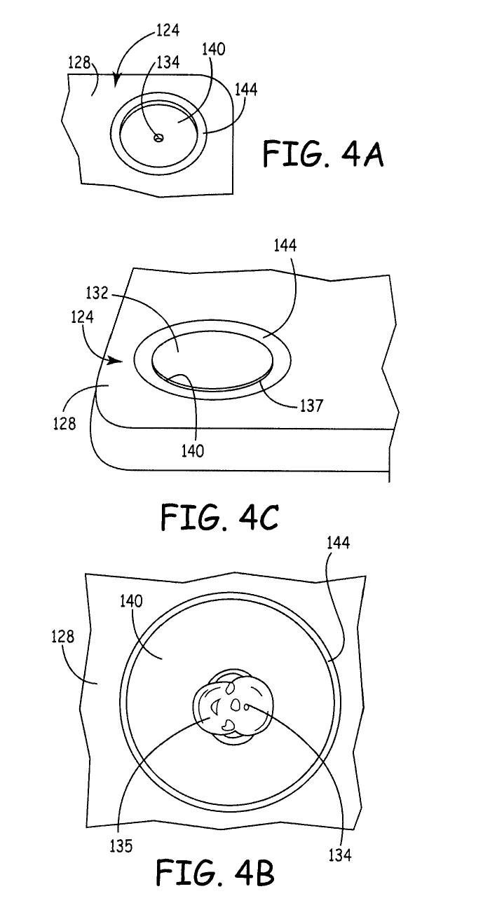

Referring now to FIGS. 4A-4C, another exemplary embodiment is illustrated. Components that are similar to those of the exemplary embodiments of FIGS. 1-3D are indicated by similar reference numerals increased by 100.

As shown in FIG. 4A, the header portion 128 includes a single filling aperture 134, which is substantially centered within the recess 140. Also, the outer rim 44 of the recess 140 can be filleted.

Then, as shown in FIG. 4B, the first seal 135 can seal the filling aperture 134. As stated above, the first seal 135 can be formed by welding, such as laser welding.

Next, as shown in FIG. 4C, the sealing member 132 can be positioned within the recess 140, and the second seal 137 can be formed between the sealing member 132 and the outer rim 144 of the recess 140. As stated above, the second seal 137 can be formed by welding, such as laser welding.

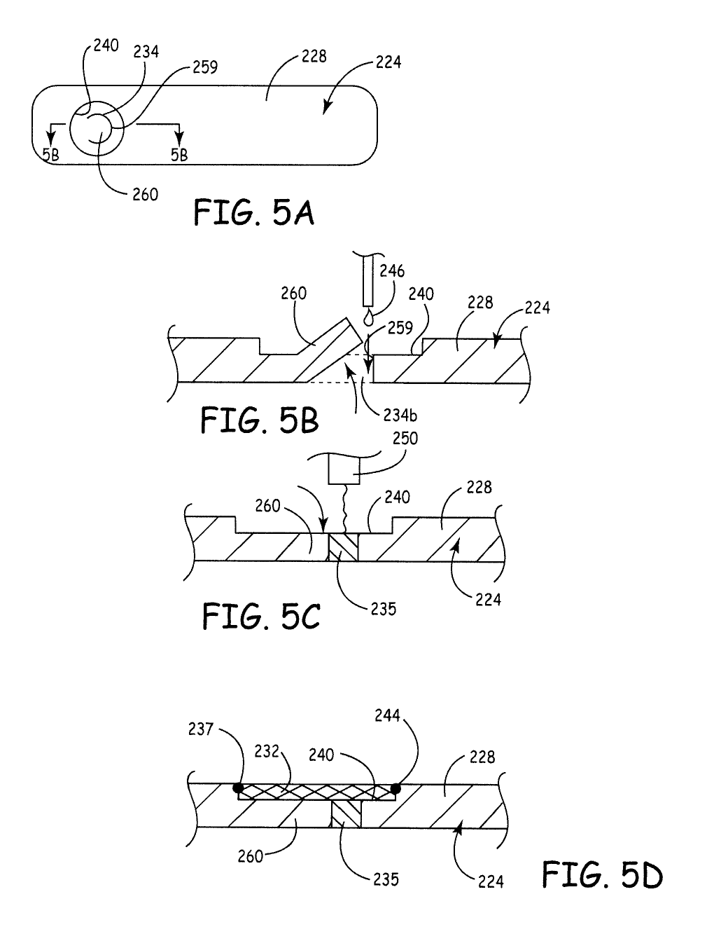

Referring now to FIGS. 5A-5D, another exemplary embodiment is illustrated. Components that are similar to those of the exemplary embodiments of FIGS. 1-3D are indicated by similar reference numerals increased by 200.

As shown in FIGS. 5A and 5B, the filling aperture 234 can be formed by forming a U-shaped or C-shaped slit 259 through the header portion 228. Then, a tab portion 260 (i.e., flap, hanging chad, etc.) resulting from the formation of the slit 259 can be moved away (e.g., rotated) from the surrounding region of the header portion 228 as represented by a curved arrow in FIG. 5B. In other words, the tab portion 260 can be bent while remaining monolithically attached to the surrounding region of the header portion 228 to enlarge the slit 259 and to enlarge the filling aperture 234.

It will be appreciated that the filling aperture 234 can be formed in any suitable fashion, such as via stamping, etc., and these methods can significantly facilitate formation of the aperture 234. Also, the electrolyte 246 can be introduced into the battery case 224 via the aperture 234, and the filling aperture 234 can be made wide relatively easily, allowing for a higher flow rate of electrolyte 246 into the battery case 224.

Then, as shown in FIG. 5C, the tab portion 260 can be moved (i.e., bent) back toward surrounding regions of the header portion 228 as represented by a curved arrow. The tab portion 260 can be moved in any suitable fashion, such as via a press or similar mechanical process/tool. Next, the first seal 235 can be formed to fully and completely attach the tab portion 260 to the surrounding region of the header portion 228 and to hermetically seal the filling aperture 234. A welding tool 250 can be used to create a welded seal of the filling aperture 234 in a manner similar to the welding process discussed above. It will be appreciated that the tab portion 260 can protect internal components of the energy storage device 16 during this process because the tab portion 260 significantly covers the filling aperture 234 while the first seal 235 is formed. For instance, if the first seal 235 is formed via laser welding, the tab portion 260 can significantly protect the cell assembly 22 (FIG. 2) from damage from the laser. Moreover, because the tab portion 260 remains partially attached (i.e., monolithically coupled in a localized region) and the first seal 235 is relatively small, the first seal 235 can be very robust, making leakage and/or contamination through the filling aperture 234 very unlikely.

Next, as shown in FIG. 5D, the sealing member 232 can be positioned within the recess 240, and the second seal 237 can be formed between the sealing member 232 and the outer rim 244 of the recess 140. As stated above, the second seal 237 can be formed by welding, such as laser welding.

Accordingly, the filling aperture(s) 34a, 34b, 134, 234 can be sealed in an uncomplicated manner with relatively few parts and relatively straightforward manufacturing steps. Accordingly, part costs for the energy storage device 16 can be reduced, and manufacturing time and effort can be significantly reduced as well. Moreover, the sealing methods described above allow the energy storage device 16 to be more compact and/or allow surrounding structures to be bigger. For instance, the anode and cathode of the cell assembly 22 can be larger, thereby advantageously increasing the energy density of the energy storage device 16.

The foregoing description of the exemplary embodiments has been provided for purposes of illustration and description. It is not intended to be exhaustive or to limit the invention. Individual elements or features of a particular exemplary embodiment are generally not limited to that particular exemplary embodiment, but, where applicable, are interchangeable and can be used in a selected exemplary embodiment, even if not specifically shown or described. The same may also be varied in many ways. Such variations are not to be regarded as a departure from the invention, and all such modifications are intended to be included within the scope of the invention.

Exemplary embodiments are provided so that this disclosure will be thorough, and will fully convey the scope to those who are skilled in the art. Numerous specific details are set forth such as examples of specific components, devices, and methods, to provide a thorough understanding of exemplary embodiments of the present disclosure. It will be apparent to those skilled in the art that specific details need not be employed, that exemplary embodiments may be embodied in many different forms and that neither should be construed to limit the scope of the disclosure. In some exemplary embodiments, well-known processes, well-known device structures, and well-known technologies are not described in detail.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method of manufacturing an energy storage device for a medical device comprising:
enclosing a cell assembly in a case, the case including a filling aperture, the filling aperture including an inner surface that is integral to the case so as to be monolithic, the case being free of a separate fill port tube;
introducing an electrolyte into the case through the filling aperture;
hermetically sealing the filling aperture to form a first seal of the filling aperture that is free of a filler material; and
hermetically sealing a sealing member to the case to form a second seal of the filling aperture.

2. The method of manufacturing of claim 1, further comprising forming a plurality of filling apertures in the case.

3. The method of manufacturing of claim 1, wherein the case further includes a recess, and the filling aperture is disposed within the recess, and further comprising positioning the sealing member in the recess.

4. The method of manufacturing of claim 3, the recess being tapered with an outer width of the recess being greater than an inner width of the recess.

5. The method of manufacturing of claim 3, wherein positioning the sealing member in the recess comprises positioning the sealing member completely between an inner surface of the recess and an imaginary surface defined by an outer rim of the recess.

6. The method of manufacturing of claim 1, wherein hermetically sealing the filling aperture comprises fusion welding the case in the presence of the electrolyte to form the first seal.

7. The method of manufacturing of claim 1, wherein hermetically sealing the sealing member to the case comprises welding the sealing member to the case to form the second seal.

8. The method of manufacturing of claim 1, the sealing member being rounded and disc-shaped.

9. The method of manufacturing of claim 1, wherein the filling aperture has a width measuring from approximately 0.004 inches to approximately 0.030 inches.

10. The method of manufacturing of claim 1, wherein the case has a thickness between approximately 0.004 and 0.032 inches.

11. An energy storage device for a medical device comprising:
a cell assembly;
a case that houses the cell assembly;
a filling aperture in the case, the filling aperture including an inner surface that is integral to the case so as to be monolithic, the filling aperture being free of a separate fill port tube;
a first seal that substantially hermetically seals the filling aperture, the first seal being free of a filler material;
a sealing member; and
a second seal that substantially hermetically seals the sealing member to the case, the second seal being redundant to the first seal and redundantly sealing the filling aperture.

12. The energy storage device of claim 11, further comprising a plurality of filling apertures in the case.

13. The energy storage device of claim 11, wherein the case defines a recess, wherein the aperture is disposed within the recess, and wherein the sealing member is disposed within the recess.

14. The energy storage device of claim 13, the recess being tapered with an outer width of the recess being greater than an inner width of the recess.

15. The energy storage device of claim 13, the sealing member being completely disposed between an inner surface of the recess and an imaginary surface defined by an outer rim of the recess.

16. The energy storage device of claim 11, the first seal being a fusion welded seal.

17. The energy storage device of claim 11, the second seal formed by welding the sealing member to the case.

18. The energy storage device of claim 11, the sealing member being rounded and disc-shaped.

19. The energy storage device of claim 11, wherein the filling aperture has a width measuring from approximately 0.004 inches to approximately 0.30 inches.

20. The energy storage device of claim 11, wherein the case has a thickness between approximately 0.004 and 0.032 inches.

21. A method of manufacturing an energy storage device for a cardiac medical device comprising:
enclosing a cell assembly in a case;
forming a recess and a filling aperture in the case, the filling aperture being disposed within the recess, the filling aperture including an inner surface that is integral to the case so as to be monolithic, the case being free of a separate fill port tube;
introducing an electrolyte into the case through the filling aperture;
fusion welding the filling aperture closed free of a filler material to form a first hermetic seal of the filling aperture;
positioning a rounded, disc-shaped sealing member in the recess such that the sealing member is completely disposed between an inner surface of the recess and an imaginary surface defined by an outer rim of the recess; and
welding the sealing member to the case to form a second hermetic seal of the filling aperture.

22. A method of manufacturing an energy storage device for a medical device comprising:
moving a tab portion of a case away from a surrounding portion of the case to define a filling aperture through the case, the tab portion remaining partially attached to the surrounding portion;
introducing an electrolyte into the case through the filling aperture;
moving the tab portion toward the surrounding portion; and
hermetically sealing the filling aperture.

23. The method of claim 22, wherein hermetically sealing the filling aperture further comprises welding the tab portion to the surrounding portion.

24. The method of claim 22, wherein hermetically sealing the filling aperture comprises forming a first seal, and further comprising providing a sealing member over the first seal and hermetically sealing the sealing member to the case to redundantly seal the filling aperture.

25. The method of claim 24, wherein hermetically sealing the sealing member to the case comprises welding the sealing member to the case.

26. The method of claim 24, further comprising providing the sealing member in a recess included in the case, the filling aperture provided in the recess.

27. An energy storage device for a medical device comprising:
a cell assembly;
a case that houses the cell assembly, the case including a tab having a first portion that is monolithically coupled to a surrounding portion of the case and a second portion that is detached from the surrounding portion, a filling aperture through the case being defined between the second portion of the tab and the surrounding portion of the case; and
a first seal that hermetically seals the filling aperture.

28. The battery of claim 27, further comprising a sealing member that is redundant to the first seal and redundantly seals the filling aperture.

29. The battery of claim 28, wherein the case includes a recess, and wherein the sealing member is disposed within the recess.

30. The battery of claim 27, wherein the filling aperture is a slit that is at least one of U-shaped and C-shaped.
